(19) United States
(12) Patent Application Publication
(10) Pub. No.: US 2012/0014651 A1
(43) Pub. Date: Jan. 19, 2012

(54) MICRO-DISTRIBUTION CABLE FOR OPTICAL COMMUNICATIONS AND METHOD FOR PRODUCING A MICRO-DISTRIBUTION CABLE

(75) Inventors: Ferenc Nad, Berlin (GB); Ulrich Hetzer, Mahlow (DE)

(73) Assignee: ADC GmbH, Berlin (GB)

(21) Appl. No.: 13/139,143

(22) PCT Filed: Nov. 9, 2009
(86) PCT No.: PCT/EP2009/007987

§ 371 Date: Oct. 3, 2011

(30) Foreign Application Priority Data
Dec. 16, 2008 (DE) 102008062535.3

(51) Int. Cl. G02B 6/44; H01R 43/00

(52) U.S. Cl. 385/109; 29/868

(57) ABSTRACT

The invention relates to a microdistribution cable (1) for optical telecommunications engineering, comprising a loose tube cable (10), at least two wires (14) being guided in the loose tube cable (10), the wires (14) of the loose tube cable (10) having been prefabricated with plugs (33) at at least one end, the microdistribution cable (1) comprising a splitting element (20), which has a first region (22), in which a portion of the loose tube cable (10) is guided, and a second region (23), in which the wires (14) are guided, the second region (23) having means for fixing tubes (12) or individual loose tube cables (47), in which the wires (14) are guided to the plugs (33), and to a method for producing a microdistribution cable (1).

The invention relates to a microdistribution cable and to a method for producing a microdistribution cable.

Microdistribution cables have a loose tube cable, in which a number of wires are guided. In this case a wire is understood to mean an optical fiber with a plastic coating. The loose tube cable has an outer sheath and an inner tube, between which aramid fibers are arranged, which are also known under the trade name KEVLAR, for example. The wires are then guided within the tube and are protected by the tube, the aramid fibers and the outer sheath. The wires are prefabricated with plugs at at least one end. The transition between the loose tube cable with the plurality of wires and the plugs can in this case be provided via tubes or individual loose tube cables in order to protect the wires. The construction of an individual loose tube cable in this case corresponds to that of a loose tube cable except for the fact that only a single wire is guided within the tube. The tube can be designed to have a correspondingly smaller diameter. If the plugs are only arranged at one end, the microdistribution cable is in the form of a pigtail. If, on the other hand, plugs are arranged at both ends, this cable is a patch cable. One problem with microdistribution cables is the fact that there may be undesirable effects on adjacent wires as a result of movements at the plugs.

DE 10 2007 009 223 A1 has disclosed a strain relief device for cables, in particular optical fiber cables, wherein the strain relief device comprises a lower part, which is in the form of a U in cross section, and an upper part, the lower part being formed on its limbs with a pivot bearing at one end side and with latching tabs at the opposite end side, which latching tabs are arranged on the inner sides of the limbs, the upper part comprising at least two sprung lateral limbs, with in each case at least one latching projection being arranged on the outer side of said lateral limbs, said latching projection, in the assembled state, latching behind the latching tabs on the lower part, and comprising shaft means, which can be inserted into the pivot bearing in the lower part.

The invention is based on the technical problem of providing a microdistribution cable and a method for producing a microdistribution cable by means of which mutual influencing of the wires is reduced.

The solution to the technical problem results from the subject matter having the features of Patent claims 1 and 8. Further advantageous refinements of the invention result from the dependent claims.

In this regard, the microdistribution cable for optical telecommunications engineering comprises a loose tube cable, at least two wires being guided in the loose tube cable, the wires of the loose tube cable having been prefabricated with plugs at at least one end, the microdistribution cable comprising a splitting element, which has a first region, in which a portion of the loose tube cable is guided, and a second region, in which the wires are guided, the second region having means for fixing tubes or individual loose tube cables, in which the wires are guided to the plugs. This results in a defined position of the wires between the loose tube cable and the tubes or individual loose tube cables, with the result that mutual interference is minimized or ruled out. It should be clarified here that the tubes which are fixed in the second region are second, further tubes, which are different from the tube of the loose tube cable. The individual loose tube cables are empty individual loose tube cables into which in each case one wire of the loose tube cable is then inserted, with the result that in each case a complete individual loose tube cable is produced.

In a preferred embodiment, ribs are arranged in the second region, with the tubes or individual loose tube cables being guided between said ribs. This makes it possible for a large number of wires to be guided and fixed.

Preferably, in each case two tubes or individual loose tube cables are guided between two ribs, with the result that a very compact design is possible.

In a further preferred embodiment, teeth for holding the tubes are arranged on the walls of the ribs, i.e. the tubes are clamped in a simple manner. This embodiment is preferably used if the tensile forces to be expected on the plugs are not excessive and do not exceed 10-20 N for example.

In an alternative embodiment, the ribs are formed with projections, the individual loose tube cables are each formed with a crimp, the crimps stopping against the projections. This embodiment is preferably used if relatively high tensile forces of >100 N can be absorbed. In this case, the crimp is preferably pushed between the outer sheath and the aramid fibers and then compressed with a sleeve.

In a further preferred embodiment, the wires and/or the loose tube cable are cast in the splitting element, this preferably taking place prior to the prefabrication with the plugs. In principle, it is also conceivable to additionally cast the tubes or individual loose tube cables in the region of the ribs. Preferably, the casting compound is in the form of a two-component epoxy resin. The wires are fixed mechanically by being cast. This results in a uniform transmission response over a wide temperature range. Without this fixing it may arise that, owing to the different temperature response of the loose tube cable sheath or tube and the wires, the wires bend in the exposed region of the wires in order to compensate for the different expansion as a result of the temperature. This bending would result in an altered transmission response, however. In this case, a coating of the wires prevents a significant amount of light from being able to emerge from the wires into the casting compound.

In a further preferred embodiment, the splitting element is in the form of a cuboid in the first region, the cuboid being narrower than the second region, the cuboid having lateral projections at that end which is remote from the second region. As a result, the splitting elements and therefore the microdistribution cables can be arranged in a strain relief device, as in DE 10 2007 009 223 A1 and can be stored in a correspondingly ordered fashion. In this case, a plurality of splitting elements and therefore cables can also be accommodated by a strain relief device.

The invention will be explained in more detail below with reference to a preferred exemplary embodiment. In the figures:

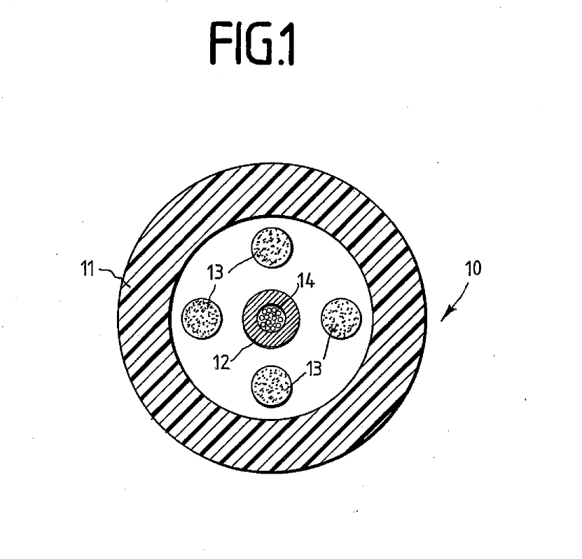

FIG. 1 shows a cross section through a loose tube cable (prior art),

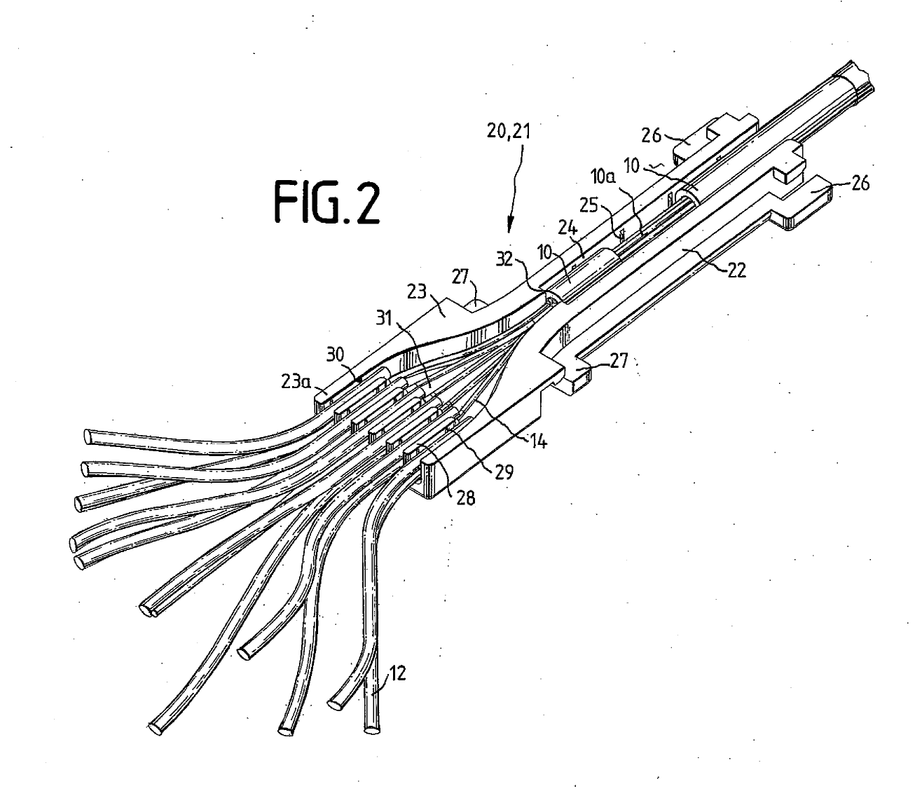

FIG. 2 shows a perspective plan view of a splitting element in a first embodiment with the upper part removed,

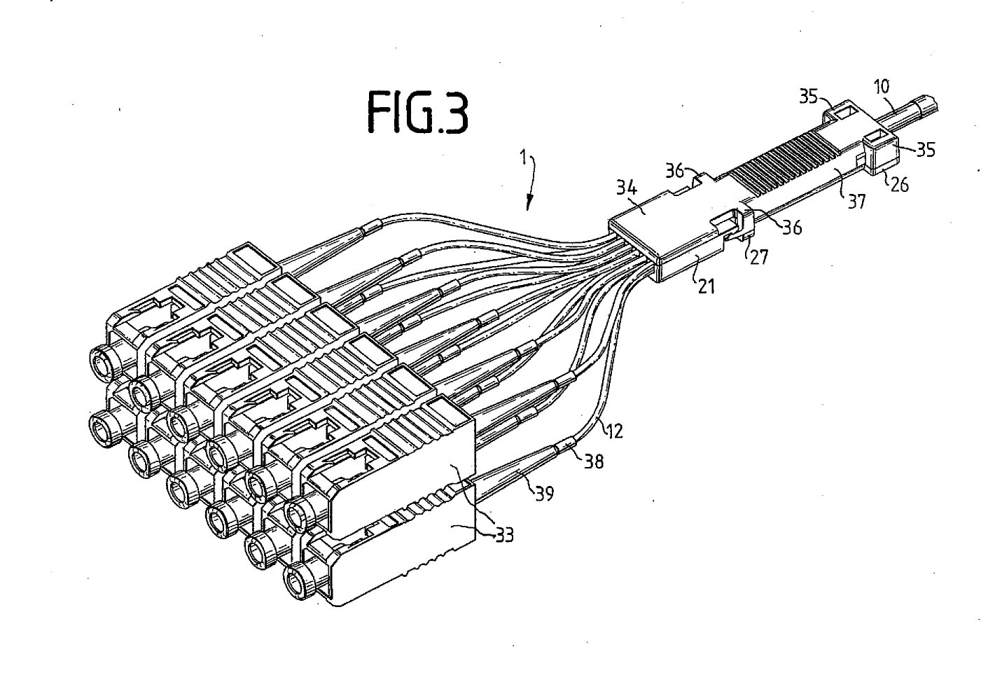

FIG. 3 shows a perspective plan view of a microdistribution cable with a splitting element from the first embodiment,

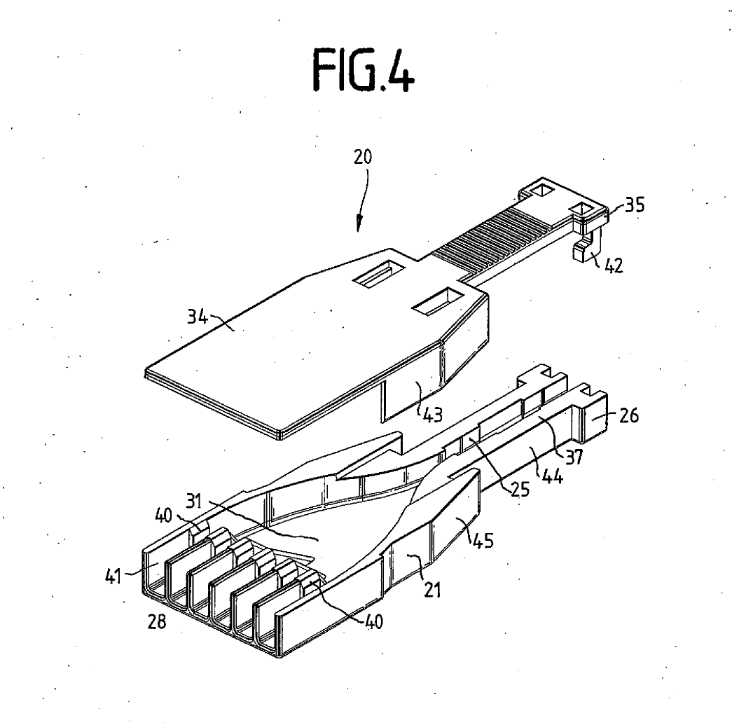

FIG. 4 shows a perspective plan view of an exploded illustration of a splitting element in a second embodiment,

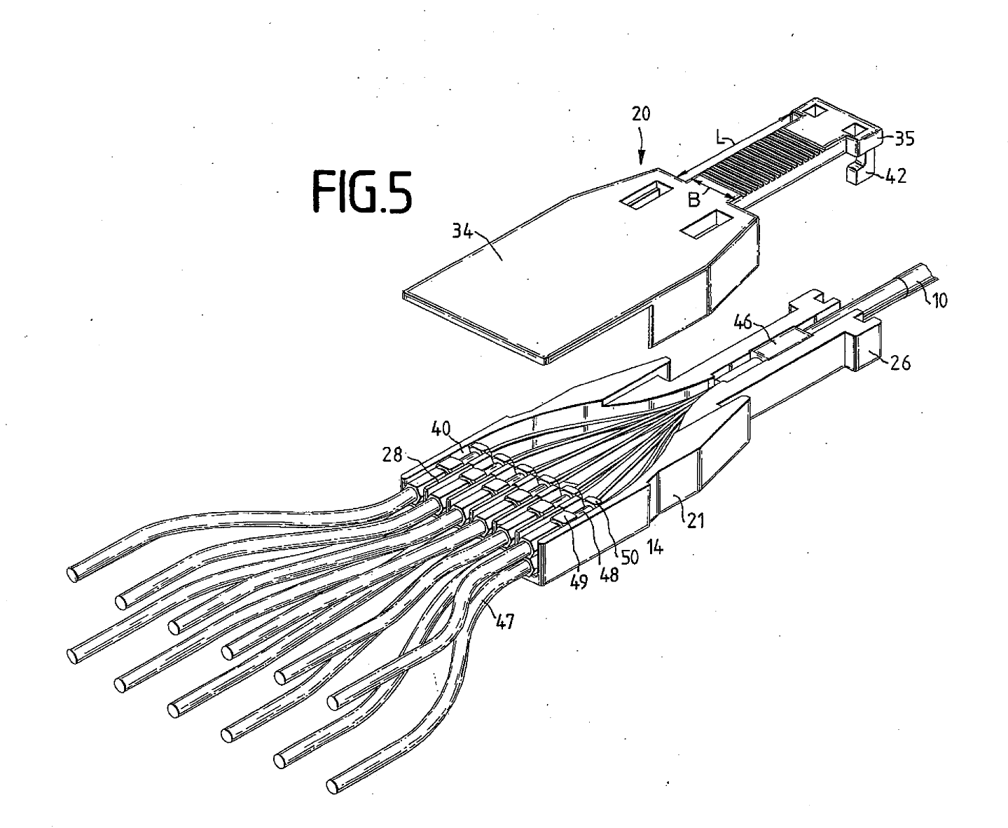

FIG. 5 shows a perspective plan view of the splitting element according to the second embodiment with the wires inserted,

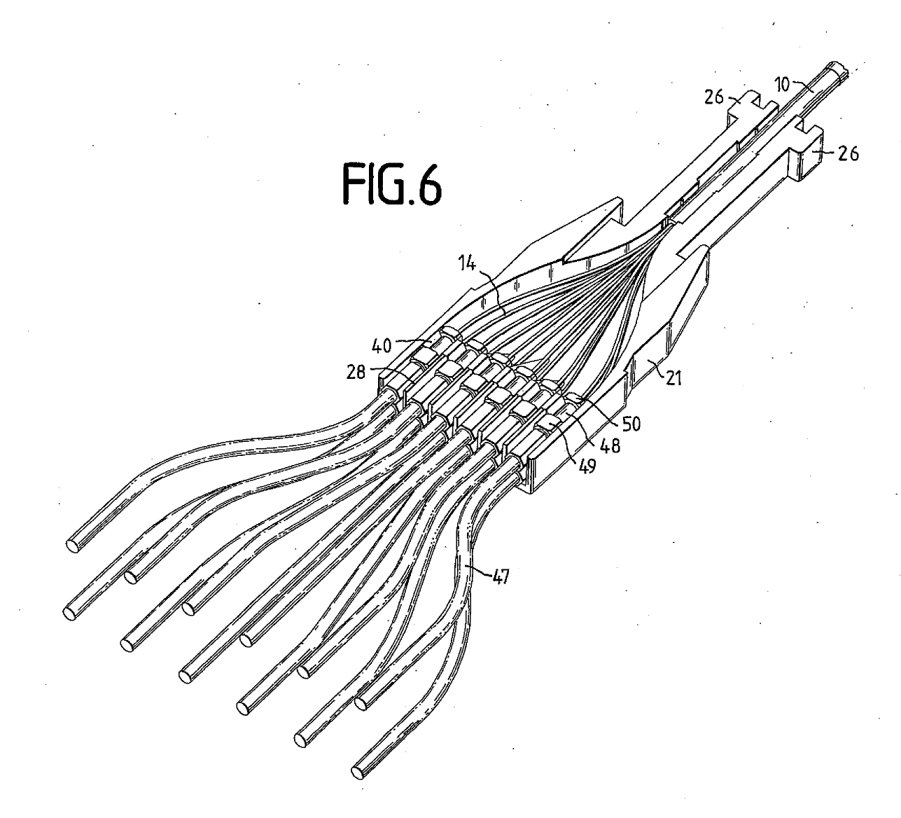

FIG. 6 shows a further perspective plan view as shown in FIG. 5 without the upper part,

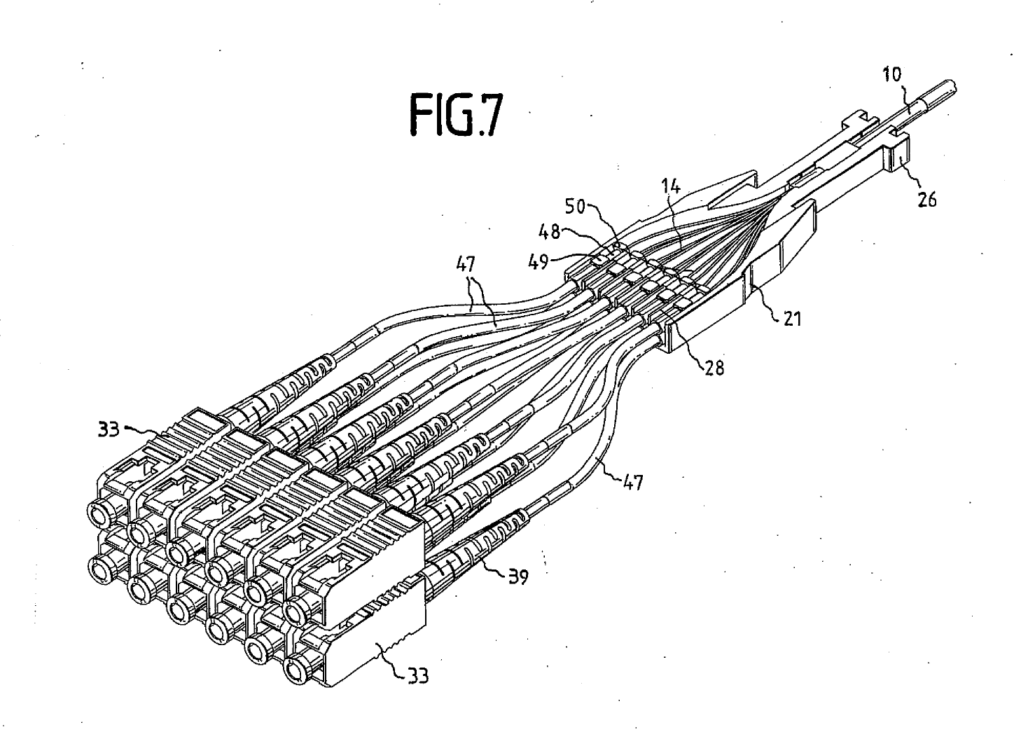

FIG. 7 shows a perspective plan view of a microdistribution cable without the upper part,

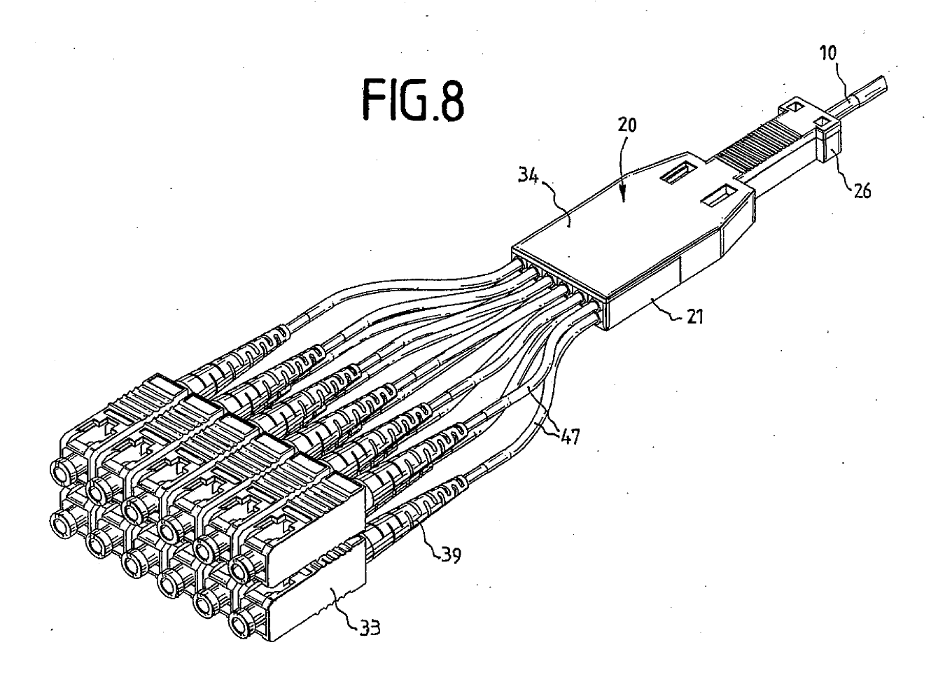

FIG. 8 shows a perspective plan view of the microdistribution cable with the upper part,

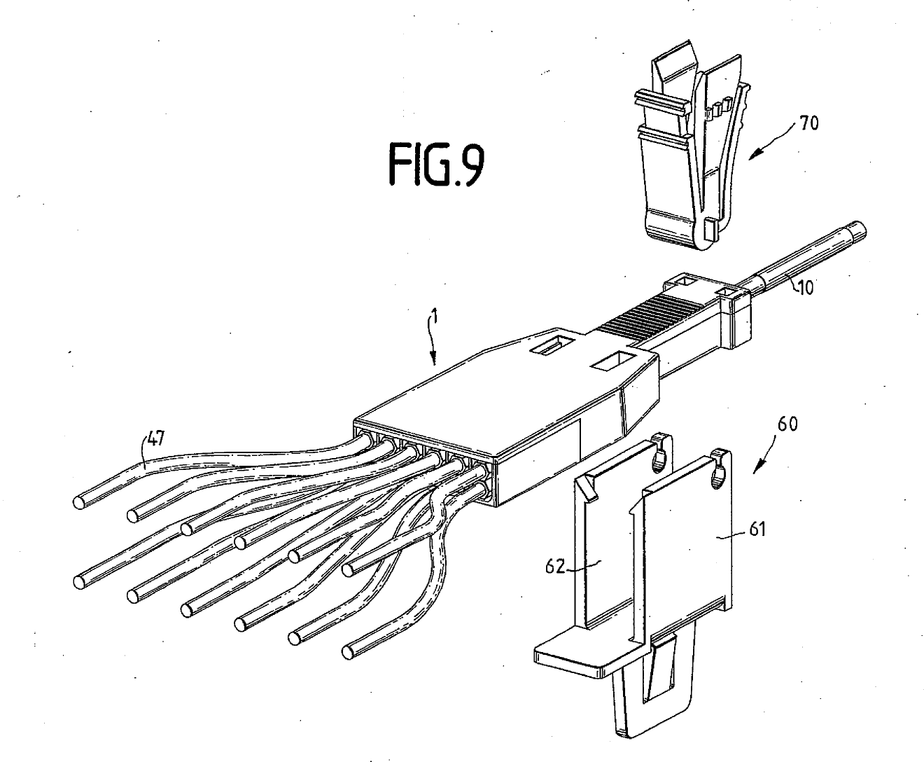

FIG. 9 shows an exploded illustration of part of the microdistribution cable and a strain relief device,

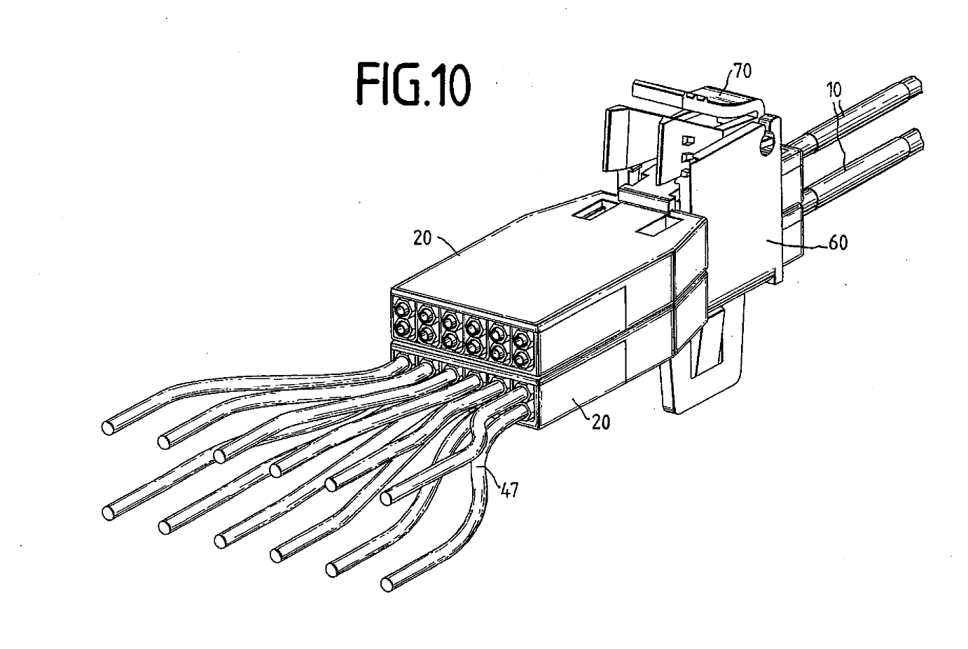

FIG. 10 shows a perspective illustration of two microdistribution cables in the inserted state within a strain relief device,

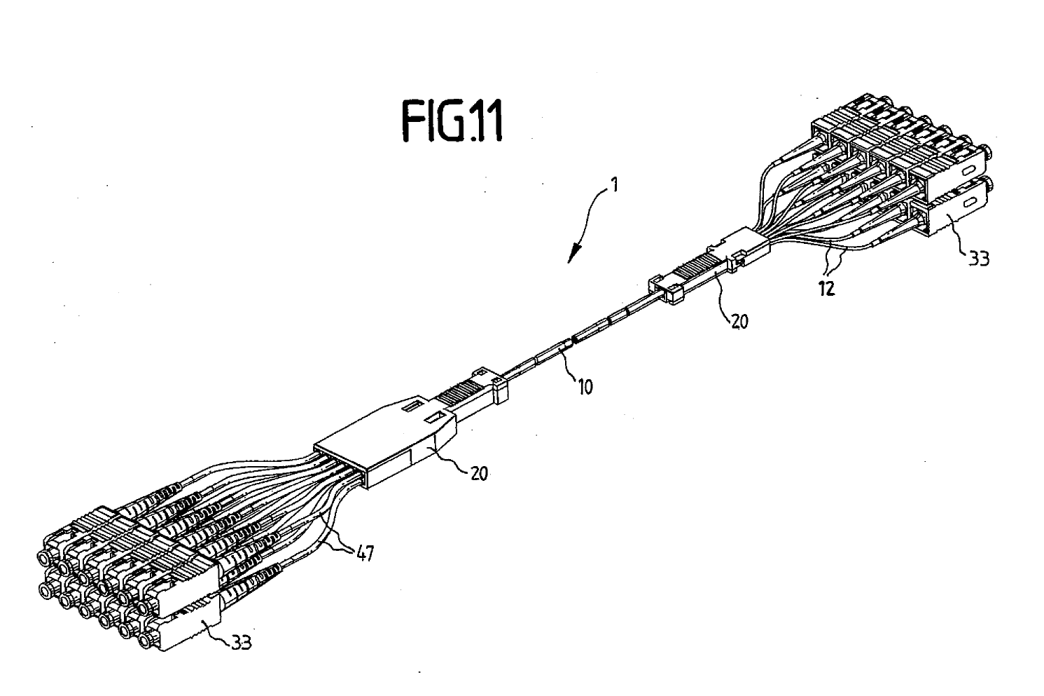

FIG. 11 shows a perspective illustration of a microdistribution cable in the form of a patch cable with in each case one splitting element from the first and second embodiments, and

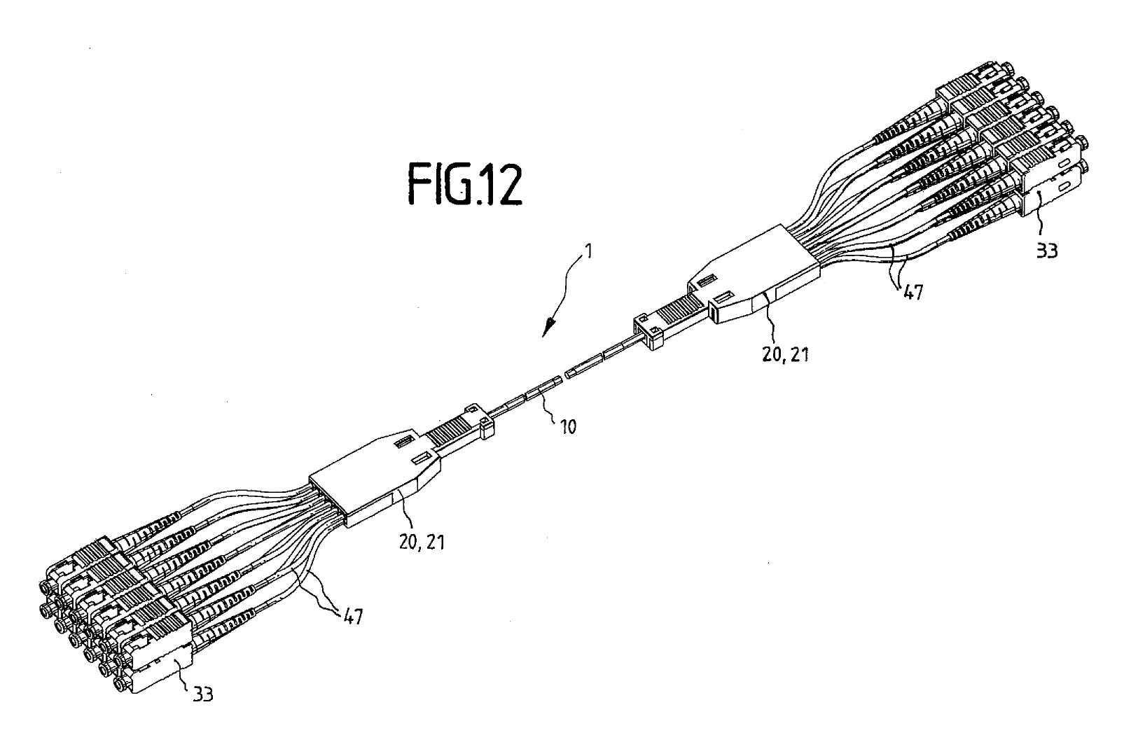

FIG. 12 shows a perspective illustration of a microdistribution cable in the form of a patch cable with two splitting elements from the second embodiment.

FIG. 1 illustrates a loose tube cable 10 in a schematic cross section. The loose tube cable 10 comprises an outer sheath 11 and an inner tube 12, aramid fibers 13 being arranged between the outer sheath 11 and the inner tube 12, which aramid fibers are wrapped around the tube 12, which is not shown here for reasons of the schematic illustration. Then, wires 14 are guided in the interior of the hollow tube 12. A typical number of wires 14 is twelve, for example. If, on the other hand, only a single wire 14 is guided, the loose tube cable 10 is also referred to as an individual loose tube cable.

FIG. 2 illustrates a lower part 21 of a splitting element 20 of a microdistribution cable in a first embodiment. The splitting element 20 comprises a first region 22 and a second region 23, the second region 23 having a front region 23A. The first region 22 has a channel-shaped indentation 24, in which a loose tube cable 10 is guided. In this case, preferably teeth 25 are arranged on the inner walls of the channel-shaped indentation 24, which teeth 25 additionally hold the loose tube cable 10. Furthermore, the first region has two lateral projections 26 at that end which is remote from the second region 23. Correspondingly, two further projections 27 are arranged at the transition to the second region 23, the function of said projections 27 being explained in more detail later. The second region 23 has a number of ribs 28 in the front region 23A, likewise with teeth 29 being arranged on the side walls of said ribs 28. Likewise, the inner side walls of the implementing element 20 have teeth 30 in the second region. In the second region 23, the channel-shaped indentation 24 of the first region 22 merges with a curved, bell-shaped indentation 31, the shape of the indentation 31 being selected such that the minimum bending radii for the wires 14 are maintained. Finally, the first region 22 also has two stop edges 32 in the channel-shaped indentation 24 before the transition to the second region 23, with the outer sheath 11 of the loose tube cable 10 stopping against said stop edges 32. The wires 14 run unprotected from the stop edges 32 and are then guided in tubes 12, which are clamped between the ribs 28. In this case, in each case two tubes 12 are clamped between two ribs 28. Owing to this arrangement, the wires 14 are guided in a defined manner between the loose tube cable 10 and the tubes 12 and are protected from damage and/or from influencing one another. The wires 14 are then guided in protected fashion to plugs 33 (see FIG. 3) within the tubes 12. The outer sheath 11 of the loose tube cable 10 has been removed in the region 10a, with the result that the aramid fibers 13 are exposed. This partial removal of the outer sheath takes place when the loose tube cable 10 or the exposed region 10a is intended to be cast, with the casting only taking place in the region 10a in the first region 22. During casting in the second region 23, the front region 23A is preferably left free, with the result that only the bell-shaped indentation 31 is cast with the wires 14. The remaining outer sheath 11 at the stop edge 32, in addition to the stop function, also has the function of holding the aramid fibers 13 in a controlled manner.

FIG. 3 finally illustrates the complete microdistribution cable 1, with additionally an upper part 34 of the splitting element 20 having been latched onto the lower part 21. In this case, the upper part 34, in the same way as the lower part 21, has projections 35, 36, with a relatively narrow cuboidal region 37 extending between said projections 35, 36. The tubes 12 are formed with connecting elements 38, by means of which the tubes 12 can be fastened on the respective anti-kink means 39 of the plugs 33. The production process in this case takes place in such a way that first, the sheath of the loose tube cable 10 is removed over a defined length of 2 m, for example (outer sheath 11 and tube 12), and then said loose tube cable is inserted into the other tubes 12 and passed through said tubes. Then, the tubes 12 are clamped firmly between the ribs 28 and possibly the wires 14 in the second region 23 and the loose tube cable 10 in the region 10a are cast. Finally, the individual wires 14 are connected to in each case one plug 33.

FIG. 4 illustrates a splitting element 20 in an alternative embodiment, with identical elements to those in the first embodiment being provided with identical reference symbols. The splitting element 20 again comprises a lower part 21 and an upper part 34. In this embodiment, projections 40 are arranged on the ribs 28 and extend at both ends of the ribs 28 up to the base of the indentation 31. Projections 40 are likewise arranged on the two inner side walls 41 of the splitting element 20. The upper part 34 is formed with various latching means 42, by means of which the upper part 34 is latched to the lower part 21. In this case, a latching means, which latches in between the side wall 44 of the cuboidal region 37 and a projection 45, is hidden by the side wall 43 of the upper part 34. In this case, the upper part 34 has a symmetrical design, with the result that the same arrangement on the other side with side wall and latching means is repeated. The distance between the ribs 28 is greater than in the first embodiment shown in FIGS. 2 and 3, which will be explained in more detail below.

FIG. 5 illustrates the splitting element 20 with wiring, the loose tube cable 10 being arranged in the channel-shaped indentation 24 and being held by an additional fixing element 46. In contrast to the embodiment shown in FIGS. 2 and 3, the wires 14 after the ribs 28 are guided not in tubes 12, but in individual loose tube cables 47. The individual loose tube cables 47 are formed so as to be fastened in the splitting element 20 with a crimp 48, the crimps 48 each having two projecting elements 49, 50, the two projecting elements 49, 50 enclosing the projection 40, which then in each case forms a stop edge for the element 49 and 50, respectively, with respect to tensioning and compression. Owing to the fact that the projections 40 are arranged in each case on both sides of the ribs 28, uniform force transmission results. The distance between the ribs 28 is therefore greater than in the embodiment shown in FIGS. 2 and 3 since the diameter of an individual loose tube cable 47 is greater than a tube 12, since the outer sheath 11 and the aramid fibers 13 are also included (see FIG. 1). However, the accommodating element 20 can absorb considerably increased tensile forces and compressive forces over the stop edges of the projections 40 than the embodiment shown in FIGS. 2 and 3.

FIG. 6 illustrates the lower part 21 without the upper part 34 and without the fixing element 46 once again in a slightly amended view.

The production process in this case takes place in similar fashion to that in the first embodiment. Again, the sheath is removed from the loose tube cable 10 first. In the next step, the individual loose tube cables 47 are crimped by virtue of the crimp 48 being pushed between the outer sheath 11 and the aramid fibers 13 and being compressed with a sleeve. Then, the individual wires 14 are guided through the individual loose tube cables 47 and the individual loose tube cables 47 are stored in the splitting element 20, and possibly the wires 14 and/or the loose tube cable 10 are cast. In the last step, the plugs 33 are then connected to the wires 14.

FIGS. 7 and 8 show the microdistribution cable 1 without the upper part 34 of the splitting element 20 (see FIG. 7) and with the upper part 34 (FIG. 8).

FIG. 9 shows part of the microdistribution cable 1 with a splitting element 20 in accordance with the second embodiment with a strain relief device in an exploded illustration. The strain relief device comprises a lower part 60, which is in the form of a U in cross section, and an upper part 70, with express reference being made to DE 10 2007 009 223 A1 as regards the operation and specific design. By means of this strain relief device, a plurality of microdistribution cables 1 can be combined in a defined manner to form a cable bundle and fastened in a defined manner via the strain relief device. Owing to the fact that the cables can be released easily by means of the upper part 70, it is also easily possible for cables to be fastened retrospectively or for fastened cables to be removed again for various purposes. The assembled state of two microdistribution cables 1 by means of a strain relief device is illustrated in FIG. 10. In this case, the width B of the cuboidal region 37 is matched to the distance between the two limbs 61, 62 of the lower part 60, and the length L of the cuboidal region 37 is matched to the length of the limbs 61, 62, with the result that the projections 26, 35 and the wider second region 23, respectively, prevent the cables from slipping out of the strain relief device. The reference symbols L, B for the second embodiment are in this case illustrated in FIG. 5. The first embodiment is dimensioned correspondingly, with the length L being defined there by the distance between the projections 26, 35 and 27, 36.

Finally, FIGS. 11 and 12 each show a microdistribution cable 1 in the form of a patch cable, with a splitting element 20 from the second embodiment being used at the front end and a splitting element 20 from the first embodiment being used at the rear end in the embodiment shown in FIG. 11. In the embodiment shown in FIG. 12, on the other hand, a splitting element 20 from the second embodiment is used both at the front and at the rear. It is naturally also possible for two splitting elements 20 from the first embodiment to be used. It should be noted that the height of the splitting elements 20 from the first embodiment corresponds to approximately ⅔ of the height of the second embodiment, with the maximum width of the first embodiment corresponding to approximately ½ the maximum width of the second embodiment.

### LIST OF REFERENCE SYMBOLS

1 Microdistribution cable
10 Loose tube cable
10a Region
11 Outer sheath
12 Tube
13 Aramid fibers
14 Wire
20 Splitting element
21 Lower part
22 First region
23 Second region
23A Front region
24 Channel-shaped indentation
25 Teeth
26 Lateral projections
27 Further projections
28 Ribs
29 Teeth
30 Teeth
31 Indentation
32 Stop edges
33 Plug
34 Upper part
35, 36 Projections
37 Cuboidal region
38 Connecting element
39 Anti-kink means
40 Projections
41 Inner side walls
42 Latching means
43 Side wall
44 Side wall
45 Projection
46 Fixing element
47 Individual loose tube cable
48 Crimp
49, 50 Projecting elements
60 U-shaped lower part
61, 62 Limbs
70 Upper part
B Width
L Length

1. A microdistribution cable for optical telecommunications engineering, comprising a loose tube cable, at least two wires being guided in the loose tube cable, the wires of the loose tube cable having been prefabricated with plugs at at least one end,
wherein the microdistribution cable comprises a splitting element, which has a first region, in which a portion of the loose tube cable is guided, and a second region, in which the wires are guided, the second region having means for fixing tubes or individual loose tube cables, in which the wires are guided to the plugs.

2. The microdistribution cable as claimed in claim 1, wherein ribs are arranged in the second region, with the tubes or individual loose tube cables being guided between said ribs.

3. The microdistribution cable as claimed in claim 2, wherein in each case two tubes or individual loose tube cables are guided between two ribs.

4. The microdistribution cable as claimed in claim 2 wherein teeth for holding the tubes are arranged on the walls of the ribs.

5. The microdistribution cable as claimed in claim 2 wherein the ribs are formed with projections, the individual loose tube cables are each formed with a crimp, the crimps stopping against the projections.

6. The microdistribution cable as claimed in claim 1, wherein the wires and/or the loose tube cable are cast in the splitting element.

7. The microdistribution cable as claimed in claim 1, wherein the splitting element is in the form of a cuboid in the first region, the cuboid being narrower than the second region, the cuboid having lateral projections at that end which is remote from the second region.

8. A method for producing a microdistribution cable from a loose tube cable with a plurality of wires, a number of plugs which corresponds to the number of wires, a number of tubes or individual loose tube cables which corresponds to the number of wires and a splitting element, comprising the following method steps:
a) removing the sheath from the loose tube cable such that the wires are exposed over a defined length,
b) inserting the exposed wires into in each case one tube or one individual loose tube cable,
c) inserting the tubes or individual loose tube cables into the splitting element, where they are fixed, and
d) connecting the wires which are guided through the tubes or individual loose tube cables to in each case one plug.

9. The method as claimed in claim 8, wherein the wires and/or the loose tube cable are cast between method steps c) and d).

10. The method as claimed in claim 8 wherein the individual loose tube cables are provided in each case with a crimp, for which purpose the crimp is pushed between the outer sheath and the aramid fibers and compressed with a sleeve.
